(19) United States
(12) Patent Application Publication
(10) Pub. No.: US 2022/0263382 A1
(43) Pub. Date: Aug. 18, 2022

(54) UNIVERSAL MOTOR KIT

(71) Applicant: Plastic Recovery Technologies Corporation, Schaumburg, IL (US)

(72) Inventor: Kevin Paul Gavin, Northbrook, IL (US)

(73) Assignee: Plastic Recovery Technologies Corporation, Schaumburg, IL (US)

(21) Appl. No.: 17/177,713

(22) Filed: Feb. 17, 2021

(51) Int. Cl. H02K 7/00

(52) U.S. Cl. CPC H02K 7/003; F16D 1/0876

(57) ABSTRACT

A universal motor kit for a trash compactor includes an electric motor including a driveshaft, one or more direct mount inserts configured at one end to couple with the electric motor driveshaft and at the other end to couple with an existing hydraulic pump, one or more C-Face shafts for coupling with the electric motor driveshaft and for use with a C-Face mount. In embodiments, the kit may include an electric motor and three direct mount inserts and one C-Face shaft for use with a C-Face mount.

### FIELD OF THE INVENTION

This invention is directed to motors for waste or trash compactors.

### DESCRIPTION OF THE RELATED ART

Commercial compactors are used in the solid waste industry to serve a variety of commercial establishments that generate significant waste streams. Such establishments include hospitals, grocery stores, retailers, airports, etc., with each of the compactors being powered by a power unit. The power units typically have an electrical control box with a programmable logic controller (PLC), and/or timers and relays that provide the commands to operate the compactor by moving a ram forward to compact the waste and reverse to the home position. Most compactors are self-contained meaning the compacting section and container that holds the solid waste are connected as one unit.

Many commercial compactor users, for example restaurants, prefer, or due to environmental reasons are required to use self-contained compactors to avoid liquid waste escaping. Such waste may be handled by a stationary compactor, which separates the compaction section that always remains on-site, with a container section that is hauled away and dumped and returned. Self-contained compactors generally utilize a 10 horsepower (HP) motor with similar specifications across different models including 3 phase power, number of RPMs (e.g., 1800), and frame size. Stationary compactors that are larger can often operate with the same 10 HP motor as the self-contained, but sometimes require a 15/20 HP motor to compact the larger waste. Again, the larger 15/20 motors specifications including 3-phase power, number of RPMs, and frame type are usually consistent across various models.

The original equipment manufacturers (OEM) who manufacture commercial compactors in the past, and currently, use a number of different electric motor manufacturers including Baldor™, WEG™, Lincoln Electric™, and Reliance Electric™. The OEM sources 10 or 15/20 HP motors with the same requirements and typically will procure a standard off the shelf motor that meets the specification for a given compactor. In the past, many OEM's sourced the motor with a specific motor manufacturer and would have the motor made proprietary with a specific proprietary part number. The OEM would specify minor changes to the motor, for example, to include a direct connection between the motor and pump with a unique keyway connection. In this case, when the motor burned out or went bad the end user would call the motor manufacturer, provide the part number and would then find out that the motor was a proprietary product to the OEM and the OEM would have to be contacted for replacement.

OEM's switched to proprietary motors for several reasons including the lower costs to direct connect the motor and hydraulic pump while maintaining off the shelf cost for the motor. This arrangement also gives the OEM a captive replacement parts business with healthy profit margins, since everyone, including the manufacturer, is restricted from selling a replacement motor with the proprietary part number.

The owner/end user of such proprietary motors have become dissatisfied for a number of reasons. One, the mark up on a proprietary motor from the OEM is typically twice the cost of an off the shelf version with the same specifications (that is readily available). In addition, the proprietary part is often not readily available and requires a long lead time. Further, a problem with either the pump or motor in a direct connect arrangement often requires replacement of both pump and motor due to difficulty in separating the parts. When such a problem occurs the motor and pump can seize up, so the end user may need to replace both parts which adds to the cost of repair. Lastly, the owner/end user would prefer the connection be done with industry standard off the shelf couplings that provide spacers between motor and pump so they can be separated easily if, and when, maintenance is required.

Accordingly, there is a need in the art for replacement motors, in particular, for commercial trash compactors, that can be readily installed in the field on a wide variety of existing OEM commercial compactor models that are currently in use in establishments nationwide.

### SUMMARY OF THE INVENTION

A universal motor kit for a trash compactor includes an electric motor including a driveshaft, one or more direct mount inserts configured at one end to couple with the electric motor driveshaft and at the other end to couple with an existing hydraulic pump, one or more mount driveshafts for coupling with the electric motor driveshaft and for use with a C-Face mount. In embodiments, the kit may include an electric motor and three direct mount inserts and one driveshaft for use with a C-Face mount.

This invention solves the problem of replacing proprietary direct connect motors or C-Face motors and provides a motor that accommodates a variety of mounting methods. The motor itself is a unique design including four new accessories. This solution provides an alternative to expensive OEM motors and provides the opportunity to upgrade to an industry standard coupling solution to provide separation between motor and pump when future repairs are needed.

Other features and aspects will be apparent from the following detailed description, the drawings, and the claims.

### BRIEF DESCRIPTION OF THE DRAWINGS

FIG. 1 shows one embodiment of a stationary waste compactor of the disclosure.

FIG. 2 shows one embodiment of a universal motor kit of the disclosure.

FIG. 3 shows one embodiment of installation of a universal motor kit of the disclosure with a hydraulic pump.

FIG. 4 shows one embodiment of the installation of a universal motor kit with a hydraulic pump in a C-Face mount (not shown) installation configuration.

FIG. 5 shows one embodiment of C-Face mount.

FIG. 6 shows another embodiment of a C-Face shaft of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

A universal motor kit for a waste compactor includes an electric motor including a drive shaft; the kit further including one or more inserts configured to fit onto a hydraulic pump shaft, and one or more shafts for a C-Face type attachment of pump and motor. The inserts may include one or more keyways for connecting the inserts to components of a hydraulic pump.

In embodiments, the one or more inserts have an outer diameter on one end configured to fit the kit provided electric motor shaft and an outer diameter at the other end configured to fit an existing hydraulic pump shaft. Each insert may further include a keyway recess for the insertion of a key for coupling an insert to a hydraulic pump. A keyway is a recess in a shaft or insert to receive a key for coupling an insert to a hydraulic pump.

In embodiments, the C-Face shaft is configured on one end to fit the electric motor shaft and on the other end to couple with an existing hydraulic pump.

In embodiments, the universal motor kit may include an electric motor, three inserts, and one C-Face shaft.

In embodiments, the electric motor may include a faceplate with tapped mounting holes. The mounting holes may be configured to accept a C-Face mount. Tapped mounting holes may also be provided for mounting bolts for an existing hydraulic pump direct connect configuration.

In embodiments, the electric motor may include a fan mounted on the motor drive shaft. The fan may turn when the driveshaft is turning thereby providing a cooling mechanism for the motor.

In embodiments, universal motor kit inserts, and shaft may be made of standard materials used for driveshafts for an electric motor including stainless steel, carbon steel, and alloys.

In embodiments, the electric motor may be a 10 hp motor a 15 hp motor or a 20 hp motor. In embodiments, the electric motor may be a 15/20 horsepower motor. In embodiments, the electric motor may be a three-phase electric motor. In embodiments, the electric motor may be configured to accept several standard voltage inputs including but not limited to 208 V, 230 V, and/or 460 V.

Three-phase motors are a type of AC motor. The motors typically consist of three main components: a stator, a rotor, and an enclosure. A stator may include a series of alloy steel laminations which are wound with wire to form induction coils, one coil for each phase of the electrical power source. The stator coils are energized from a three-phase power source. The rotor may contain induction coils and metal bars connected to form a circuit. The rotor surrounds the motor shaft and is the motor component that rotates to produce mechanical energy output of the motor.

An enclosure of the motor may hold the rotor with its motor shaft on a set of bearings to reduce the friction of the rotating shaft. The enclosure may have end caps that hold the bearing mounts and house a fan that can be attached to the motor shaft which spins as the motor shaft turns. The spinning fan draws ambient air from outside the enclosure and forces the air across the stator and rotor to cool the motor components and dissipate heat. The enclosure may also have fins on the exterior that serve to further conduct heat to the outside air. The end cap may also provide a location to house electrical connections for the three-phase power to the motor.

The accessories included with the universal motor kit each provide a solution to a separate type of motor to pump mount. The accessories cover all methods of motor to pump mount and include all industry standard sizes to cover all the various OEMs. Accordingly, the disclosed universal motor kit may fit the vast majority of commercial waste compactors currently in use.

In one example, installation of an electric motor in an existing waste compactor may include selecting an insert from the kit to fit the hydraulic pump shaft in the compactor. Installing the insert on the existing hydraulic pump shaft. Inserting the hydraulic pump into the universal motor provided with the universal motor kit at the driveshaft.

In another example, a C-Face shaft is installed into the driveshaft of the electric motor provided with the kit. A motor coupling attachment is added to the shaft. A pump coupling attachment is connected to the motor coupling attachment added to the shaft.

A ‘C-Face’ motor is a common mechanical standard designed with a flange on the face of the motor for mounting purposes. The weight of the C-Faced motor is supported by the flange, which is commonly attached to a gearbox. The flange is strong enough to support the motor.

A C-Face mount may incorporate a machined-face flange and a connector on the end of the shaft to allow direct-coupling with equipment, for example, a hydraulic pump. Bolts pass from the mounting-face through threaded-holes in the motor.

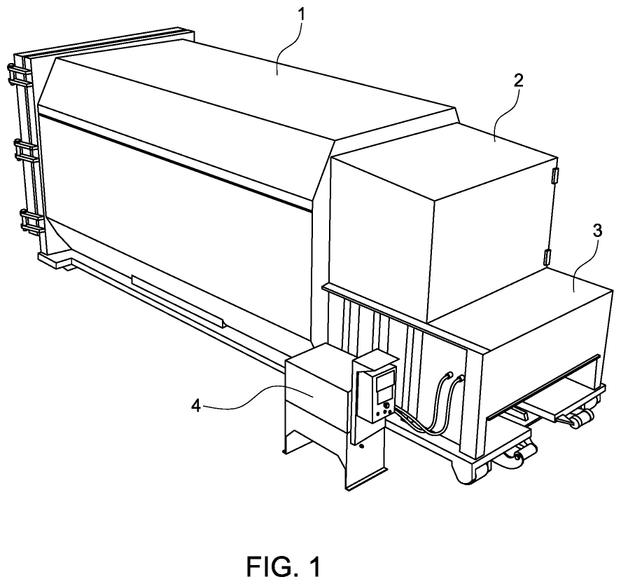

FIG. 1 shows one embodiment of a stationary waste compactor of the disclosure. FIG. 1 shows container for stored waste 1, feeder to place trash 2, compactor head 3 which compacts trash, and power unit and controls 4.

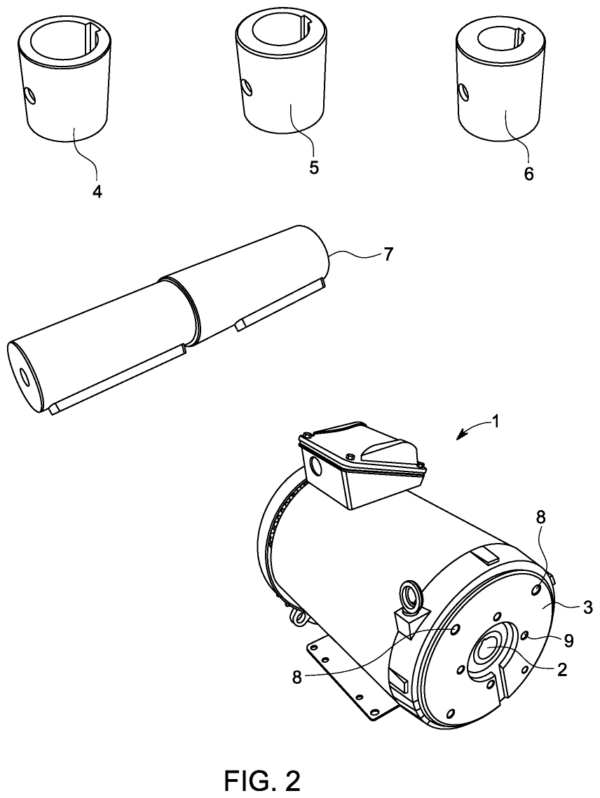

FIG. 2 shows an embodiment of universal motor kit of the disclosure. FIG. 2 shows electric motor 1 with faceplate 3, with tapped mounting holes for a C-Face mount 8 and tapped mounting holes 9 for direct connection of a hydraulic pump (not shown), driveshaft 2, direct mount inserts of various sizes 4, 5, and 6, and C-Face shaft 7 for use with a C-Face mount.

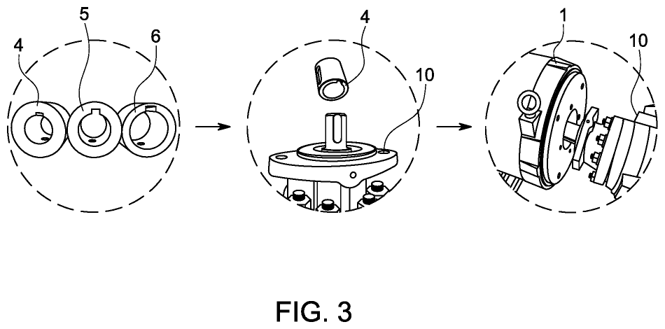

FIG. 3 shows an embodiment of installation of a direct connect to a hydraulic pump. FIG three shows direct mount inserts 4, 5, and 6, then selecting and installing insert 4 to hydraulic pump 10, and then inserting hydraulic pump 10, with direct mount insert connected to driveshaft of electric motor 1.

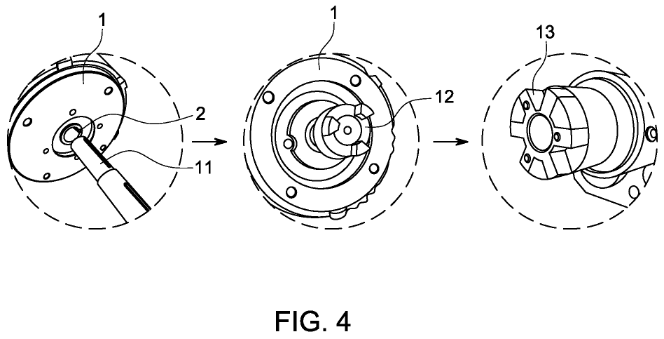

FIG. 4 shows an embodiment of installation for a C-Face type connection configuration. FIG. 4 shows installing universal motor kit C-Face shaft 11 to electric motor 1 driveshaft 2, adding a hydraulic pump motor coupling connector 12, and connecting coupling connector 12 with coupling connector 13 (located on a hydraulic pump).

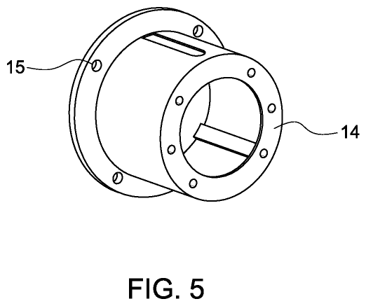

FIG. 5 shows an embodiment of C-face mount 14 with mounting holes 15.

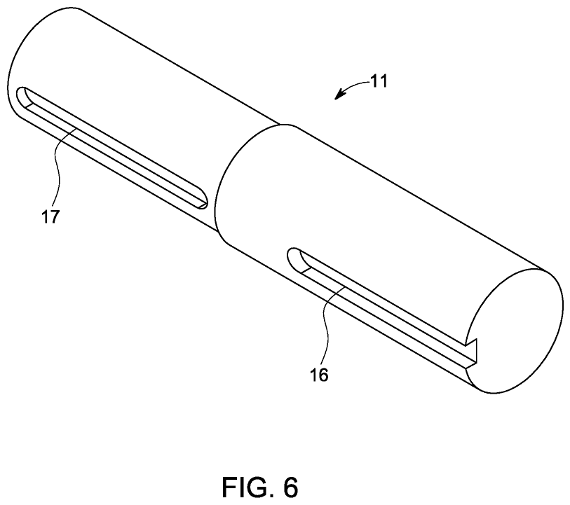

FIG. 6 shows another embodiment of a C-Face shaft 11 with keyways 16 and 17.

### EXAMPLES

In one example of a universal motor kit of the disclosure, a universal motor kit includes each of the following components.

A 10 hp electric motor equipped with a driveshaft and faceplate configured for a standard C-Face mount and tapped mounting holes for direct mounting or connecting to a hydraulic pump.

A ⅝″ outer diameter (OD) direct mount insert with 5/32″ keyway to allow a direct mount between a motor/pump connection. As one example, this configuration fits PTR Baler & Compactor™ models, and also fits several other OEM trash compactor motors.

A ¾″ outer diameter direct mount insert with 3/16″ keyway is used for a direct mount motor/pump. This configuration fits OEM's including Cram-A-Lot™ and WasteQuip™ as well as other OEM's using the same specifications.

A ⅞″ outer diameter direct mount insert with ¼″ key is provided to replicate a motor to pump connection. This configuration fits the major OEM Marathon™ brand and other OEMs using this same specification.

Each direct mount insert is configured on one end to fit the electric motor driveshaft.

A C-Face shaft is used to connect the motor and pump through a coupling connection that provides separation between the electric motor and a hydraulic pump, if and when future repairs may be needed. The C-Face shaft may range in length from 2 inches to 12 inches and have an outer diameter ranging from approximately 1/2 inch to 1 inch.

In a second example, a universal motor kit includes a 15/20 hp motor with the above-described components.

While this disclosure includes specific examples, it will be apparent after an understanding of the disclosure of this application has been attained that various changes in form and details may be made in these examples without departing from the spirit and scope of the claims and their equivalents.

1. A universal motor kit for a trash compactor comprising:
an electric motor comprising a driveshaft;
one or more direct mount inserts configured at one end to couple with the electric motor driveshaft and at the other end to couple with an hydraulic pump;
one or more C-Face shafts for use with a C-Face mount.

2. The universal motor kit of claim 1, wherein three direct mount inserts are included.

3. The universal motor kit of claim 1, including one mount shaft for use with a C-Face mount.

4. The universal motor kit of claim 1 comprising:
three direct mount inserts; and
one C-Face-shaft for use with a C-Face mount.

5. The universal motor kit for a trash compactor of claim 1, wherein the electric motor is a 10 hp electric motor.

6. The universal motor kit for a trash compactor of claim 1, wherein the electric motor is a 15 hp electric motor.

7. The universal motor kit for a trash compactor of claim 1, wherein the electric motor is a 20 hp electric motor.

8. The universal motor kit for a trash compactor of claim 1, wherein each driveshaft and direct mount insert comprises carbon/stainless steel.

9. A universal motor kit for a trash compactor comprising:
an electric motor comprising a driveshaft, wherein the electric motor is a 10 hp, 15 hp, or 20 hp electric motor;
a direct mount insert configured at one end to couple with the electric motor driveshaft and at the other end with an approximately ⅝ inch outer diameter;
a direct mount insert configured at one end to couple with the electric motor driveshaft and at the other end with an approximately ¾ inch outer diameter;
a direct mount insert configured at one end to couple with the electric motor driveshaft and at the other end with an approximately ⅞ inch outer diameter;
a C-Face shaft ranging in length from 2 inches to 12 inches and an outer diameter ranging from approximately ½ inch to 1 inch for a C-Face mount.

10. The universal motor kit for a trash compactor of claim 8, wherein each direct mount insert and driveshaft comprise carbon/stainless steel.
